(19) United States
(12) Patent Application Publication
(10) Pub. No.: US 2015/0334785 A1
(43) Pub. Date: Nov. 19, 2015

(54) MENU-BASED COOKING APPLIANCE

(71) Applicant: CookTek Induction Systems, LLC, Chicago, IL (US)

(72) Inventors: Robert J. Visher, Downers Grove, IL (US); Warren S. Graber, Hoffman Estates, IL (US); Reinhard Metz, Wheaton, IL (US)

(21) Appl. No.: 14/713,123

(22) Filed: May 15, 2015

Related U.S. Application Data
(60) Provisional application No. 61/993,888, filed on May 15, 2014.

(51) Int. Cl. H05B 6/12; G06F 3/0482; G06F 3/0484; H05B 6/06

(52) U.S. Cl. CPC H05B 6/1209; H05B 6/062; H05B 6/065; G06F 3/0482; G06F 3/04842; G06F 3/04847

(57) ABSTRACT

A cooking apparatus including a heating element; a user-interface mechanism having a user-input for receiving at least one input from a user and a display for presenting at least one instruction to the user; and a controller configured to perform a recipe. The recipe includes an instruction phase, the instruction phase including operating the display to present an instruction to the user until at least one event occurs, the event selected from the group of events consisting of a first predetermined time elapsing and an input being received, and an execution phase, the execution phase including operating the heating element at a predetermined temperature or power level until a second predetermined time has elapsed.

### RELATED APPLICATIONS

This application claims the benefit of prior-filed U.S. Provisional Patent Application No. 61/993,888 filed on May 15, 2014, the entire contents of which are hereby incorporated by reference.

### BACKGROUND

The present invention generally relates to cooking appliances, such as but not limited to, stoves, ranges, cooktops, cooking plates, ovens, broilers, grills, microwave ovens, and griddles.

Typically, cooking appliances are manually set at an operating power level (e.g. for range tops) or temperature (e.g. for ovens) and continue to operate at that set power level or temperature until the operating power level or temperature is manually reset. This can often lead to operator error, which can result in reduced food quality and inconsistencies in the food products.

### SUMMARY

In one embodiment, the invention provides an induction cooking apparatus including a heating element; a user-interface having a user-input mechanism for receiving at least one input from a user and a display for presenting at least one instruction to the user; and a controller configured to perform a recipe. The recipe includes an instruction phase, the instruction phase including operating the display to present an instruction to the user until at least one event occurs, the event selected from the group of events consisting of a first predetermined time elapsing and an input being received, and an execution phase, the execution phase including operating the heating element at a predetermined temperature or power level until a second predetermined time has elapsed.

In another embodiment the invention provides a method of controlling an induction cooking appliance. The method includes the steps of: receiving a recipe; displaying an instruction to a user according to the recipe, the instruction being displayed until at least one event occurs, the event selected from the group of events consisting of a first predetermined time elapsing and an input being received from the user; and operating a heating element of the induction cooking appliance according to the recipe, the heating element being operated at a predetermined temperature or power level until a second predetermined time has elapsed.

In still another embodiment the invention provides an induction cooking appliance network system. The system includes a first induction cooking appliance including a first heating element and a first user-interface; a second induction cooking appliance communicatively coupled to the first induction cooking appliance, the second induction cooking appliance including a second heating element and a second user-interface; and a main computer communicatively coupled to the first induction cooking appliance and the second induction cooking appliance. The main computer is operable to display an instruction to a user via at least one interface selected from the group of interfaces consisting of the first user-interface and the second user-interface, the instruction displayed according to a recipe, the instruction being displayed until at least one event occurs, the event selected from the group consisting of a first predetermined time elapsing and an input being received from the user, and operate at least one heating element selected from the group of heating elements consisting of the first heating element and the second heating element, according to the recipe, wherein the selected heating element, when operated, is operated at a predetermined temperature or power level until a second predetermined time has elapsed.

In yet another embodiment, the invention provides a computer-based recipe creation and management system. The system includes a recipe builder module and an execution module. The recipe builder module is for creating a recipe having one or more steps, each step of the recipe builder module including an instruction area and an execution and status area. The instruction area includes one or more of the following user inputs: an instruction text input, a flash instruction input, and an audible instruction alarm input. The execution and status area includes one or more of the following user inputs: a temperature or power level input, a time input, a show stir message input, a stir interval input, a flash status input, an audible status alarm input, and an execution and status text box input. The execution module is for executing recipes and includes a controller in communication with a user interface and an induction cooking system. The controller is configured to determine if a recipe has been selected by a user, detect a pan on a cooking area of the induction cooking system, display a first step of the recipe selected by the user on the user interface, and adjust a temperature or power level of the cooking area of the induction cooking system.

Other aspects of the invention will become apparent by consideration of the detailed description and accompanying drawings.

### BRIEF DESCRIPTION OF THE DRAWINGS

FIG. 1 illustrates a perspective view of a cooking system according to one embodiment of the invention.

FIG. 2 illustrates a block diagram of a control system of the cooking system of FIG. 1.

FIGS. 3A-3D illustrate one embodiment of a user-interface of the cooking system of FIG. 1.

FIGS. 4A and 4B illustrate a flowchart of one operation of the cooking system of FIG. 1.

FIG. 5 illustrates one embodiment of a recipe computer program used in conjunction with the cooking system of FIG. 1.

FIGS. 6A and 6B illustrate another embodiment of a recipe computer program used in conjunction with the cooking system of FIG. 1.

FIGS. 7A and 7B illustrate a flowchart of another operation of the cooking system of FIG. 1.

FIG. 8 illustrates a flowchart of another operation of the cooking system of FIG. 1.

FIG. 9 illustrates a network used in conjunction with the cooking system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

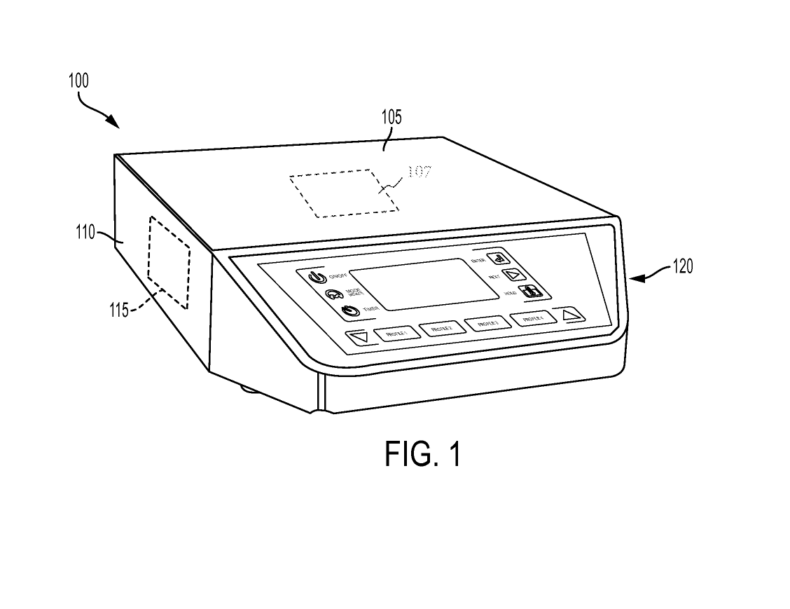

FIG. 1 illustrates a perspective view of a cooking system 100. The cooking system 100 includes a cooking area, or surface, 105, a housing 110, a control system 115, and a user-interface 120.

In one embodiment, the cooking area 105 is an induction cooking area. In such an embodiment, the induction cooking system 100 includes a heating element, such as but not limited to a coil, located beneath the cooking area 105 within the housing 110. The coil is configured to produce an oscillating magnetic field operating at, e.g. 20 to 30 kHz. In operation, the oscillating magnetic field heats a cooking vessel, such as a pot or pan (typically made of a ferromagnetic material such as iron or steel), which has been placed on the cooking area 105. The oscillating magnetic field heats the material of the cooking vessel by generating small eddy currents within the material and by causing oscillation of magnetic dipoles within the material. The heat produced is proportional to the induced current. Although the cooking vessel is generically described below as a pan, the cooking area 105 is operable to receive, and operate with, any type of cooking vessel. While the induction cooking system is shown and described as employing cooking vessels which rest on a flat cooking area 105, in some embodiments the cooking vessel may be a container which is inserted into a drop-in cooking area 105 which includes sides which make up a well with an induction coil at the base of the well, for example in a “steam table”-type device or soup warming well, similar to the configurations disclosed in US Patent Appl. Publ. No. 2012/0294990, incorporated herein by reference in its entirety. In still other embodiments the cooking area 105 may include a depression for receiving a wok-like cooking vessel. In yet other embodiments, the cooking area 105 is a gas-powered range or an electric range. In another embodiment, the cooking area 105 is an oven, broiler, grill, microwave oven, etc.

In various embodiments, the induction-based cooking system 100 may operate at a variety of power levels, for example ranging from 100 watts to 2 kilowatts, where most of the power (typically 90%-95%) is absorbed by the cooking vessel. Compared to other cooking methods such as electric or gas, induction cooking is extremely efficient and, as a result, power control is more reliable. The fact that the coil of an induction cooking system produces a magnetic field which acts largely on the cooking vessel that is resting on the cooking area 105 means that there is relatively little loss of energy, unlike gas and electric heating units in which much of the heat energy escapes without heating the cooking vessel or the food. Induction heating provides a greater degree of control over food preparation than other forms of heating due to the minimal losses of energy and due to the extremely fine level of adjustment of energy input that is possible with induction. As described below, control of induction-based cooking can be enhanced even further by measuring the temperature of the cooking vessel and using the temperature information in a feedback loop to increase or decrease the temperature of the cooking vessel during execution of a recipe and/or to maintain the cooking vessel at a steady temperature during one or more steps of recipe execution.

In some embodiments, the cooking area 105 includes a sensor 107 operable to sense when the cooking vessel is placed within the cooking area 105. The sensor 107 may be, but is not limited to, a push-button sensor, an optical sensor, or a magnetic sensor. In other embodiments, the induction coil can be used to determine whether a cooking vessel is present, since the amount of power that can be delivered using the coil is impacted by the presence or absence of an object to receive the power. In certain embodiments, sensor 107 may include a temperature sensor instead of, or in addition to, the sensor for detecting the presence of a cooking vessel in the cooking area 105. In various embodiments, the temperature sensor may measure the temperature of the cooking area 105 (e.g. the surface on which the cooking vessel rests) and/or the temperature sensor may measure the temperature of the vessel itself, for example via infrared sensing or by direct contact with the bottom of the cooking vessel (e.g. a resistive thermal device, or RTD). Infrared sensing may be conducted through a window of infrared-transmitting material in the surface of the cooking area 105 in the sensor 107 region. In some embodiments, infrared temperature sensing is combined with direct contact sensing (e.g. using an RTD) to provide more accurate temperature readings. Further details of temperature sensing systems and methods are disclosed in U.S. Provisional Patent Application 62/015,755 filed Jun. 23, 2014 (Atty. Ref. 206855-9001-US00), which is incorporated herein by reference in its entirety. In certain embodiments the temperature of the cooking vessel may be used to detect whether the vessel is empty or has boiled dry, by detecting and recording a temperature profile and comparing the recorded profile to one or more predetermined profiles which are indicative of an empty or nearly empty vessel. In general, an empty or nearly empty cooking vessel (which may be produced, e.g., by cooking food product for too long until it is dried out or failing to add any ingredients or sufficient amounts of ingredients) heats at a faster rate than a vessel which has food present, since the heat put into the cooking vessel is transferred to the food.

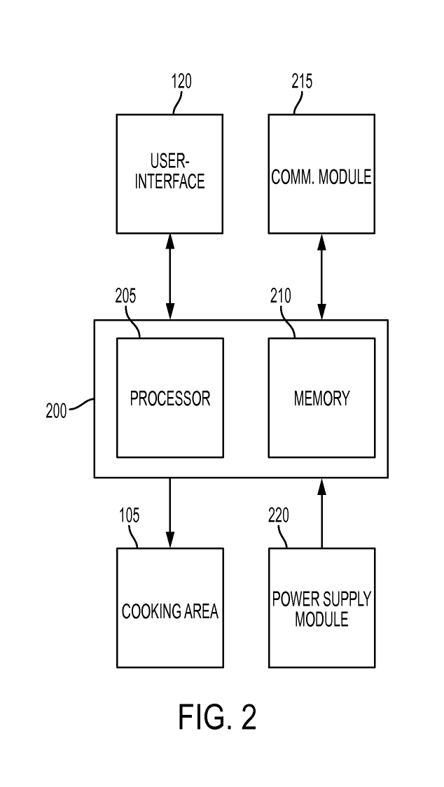

FIG. 2 is a block diagram of the control system 115. The control system 115 is located within the housing 110. The control system 115 includes a controller 200. The controller 200 is electrically connected to the cooking area 105 and controls the cooking area 105. Control of the cooking area 105 includes, but is not limited to, setting an operating temperature, an operating power level, and an operating time.

The controller 200 includes a processor 205 and a memory 210. The processor 205 is configured to retrieve from memory 210 and execute, among other things, instructions related to the control processes and methods described herein.

The controller 200 is further connected to a communications module 215. The communications module 215 provides connection and communication between the controller 200 and an outside, or external, device. In some embodiments, the communications module 215 includes one or more communications ports (e.g., Ethernet, serial advanced technology attachment [“SATA”], universal serial bus [“USB”], integrated drive electronics [“IDE”], etc.) for transferring, receiving, or storing data, associated with the cooking system 100 or the operation of the cooking system 100, from the outside device to the controller 200.

In some embodiments, the communications module 215 provides communication between the controller 200 and a network. In such an embodiment, the network may be, for example, a wide area network (“WAN”) (e.g., a TCP/IP based network, a cellular network, such as, for example, a Global System for Mobile Communications [“GSM”] network, a General Packet Radio Service [“GPRS”] network, a Code Division Multiple Access [“CDMA”] network, an Evolution-Data Optimized [“EV-DO”] network, an Enhanced Data Rates for GSM Evolution [“EDGE”] network, a 3GSM network, a 4GSM network, a Digital Enhanced Cordless Telecommunications [“DECT”] network , a Digital AMPS [“IS-136/TDMA”] network, or an Integrated Digital Enhanced Network [“iDEN”] network, etc.).

In another embodiment the network may be, for example, a local area network (“LAN”), a neighborhood area network (“NAN”), a home area network (“HAN”), or personal area network (“PAN”) employing any of a variety of communications protocols, such as Wi-Fi, Bluetooth, ZigBee, etc. The connections between the communications module 215 and the network are, for example, wired connections, wireless connections, or a combination of wireless and wired connections.

In some embodiments, the cooking system 100 may also include an application that operates remotely to assist a user in preparing a recipe; these recipes may then be transmitted to the housing 110 (for execution via the controller 200) using any of a number of wired or wireless communications mechanisms. The application, the operation of which is described below, may be a software program for running on a conventional computer or an “app” for a mobile device such as a smartphone or tablet, or the application may be accessible through a web browser which is usable from a variety of stationary or mobile computing platforms. The mechanisms for transmitting the recipes to the housing 110/controller 200 can include various wired or wireless mechanisms such as a serial (e.g. USB) cable, a flash drive (e.g. plugged into a USB port on the housing 110), wifi, Bluetooth, Zigbee, or a wired network connection, as discussed above. In various embodiments the system 100 includes suitable wired and/or wireless networking capabilities, for example as part of the communications module 215 described above, incorporated into the housing 110 and in communication with the controller 200.

The controller 200 is further connected to a power supply module 220. The power supply module 220 supplies a nominal AC or DC voltage to the controller 200 or other components or modules of the cooking system 100. The power supply module 220 is powered by, for example, a power source having nominal line voltages between 100V and 240V AC and frequencies of approximately 50-60 Hz. The power supply module 220 is also configured to supply lower voltages to operate circuits and components within the controller 200 or cooking system 100.

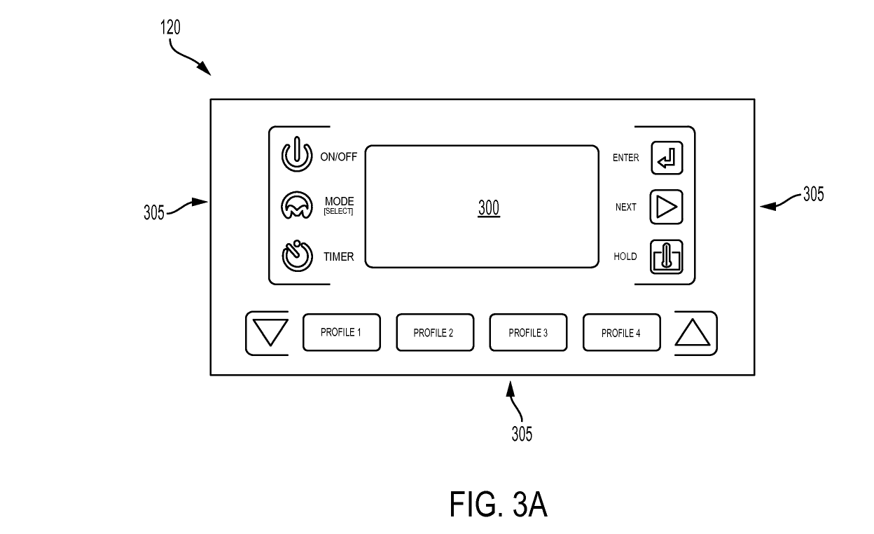

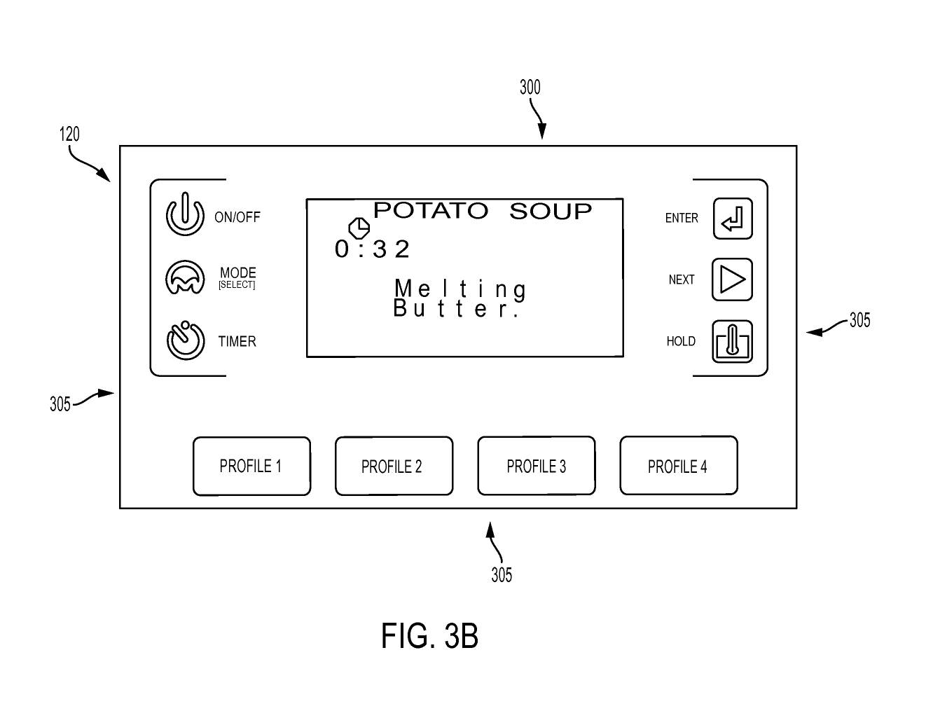

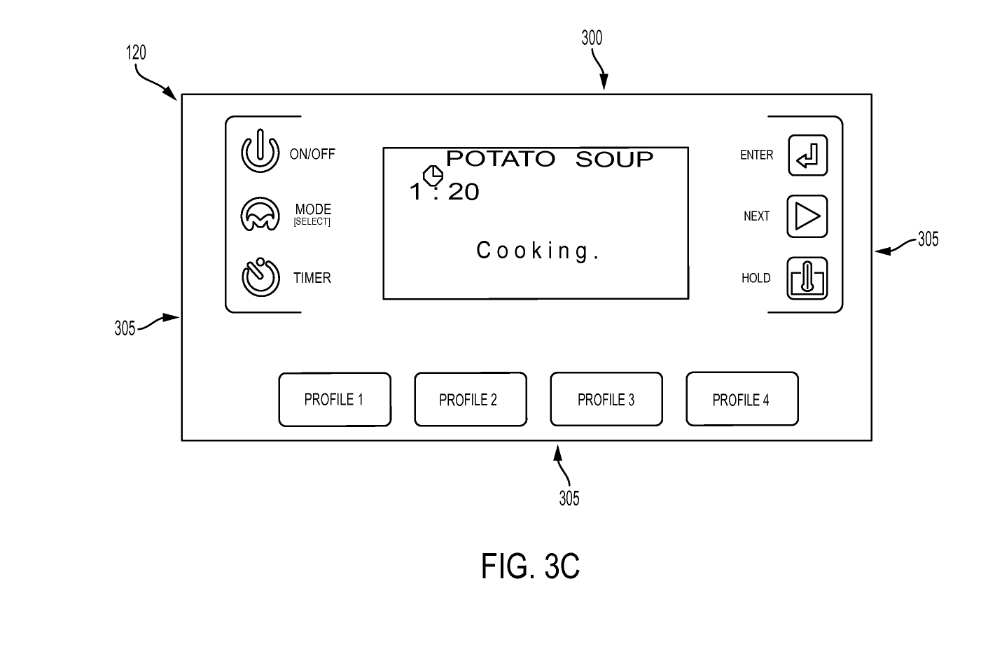

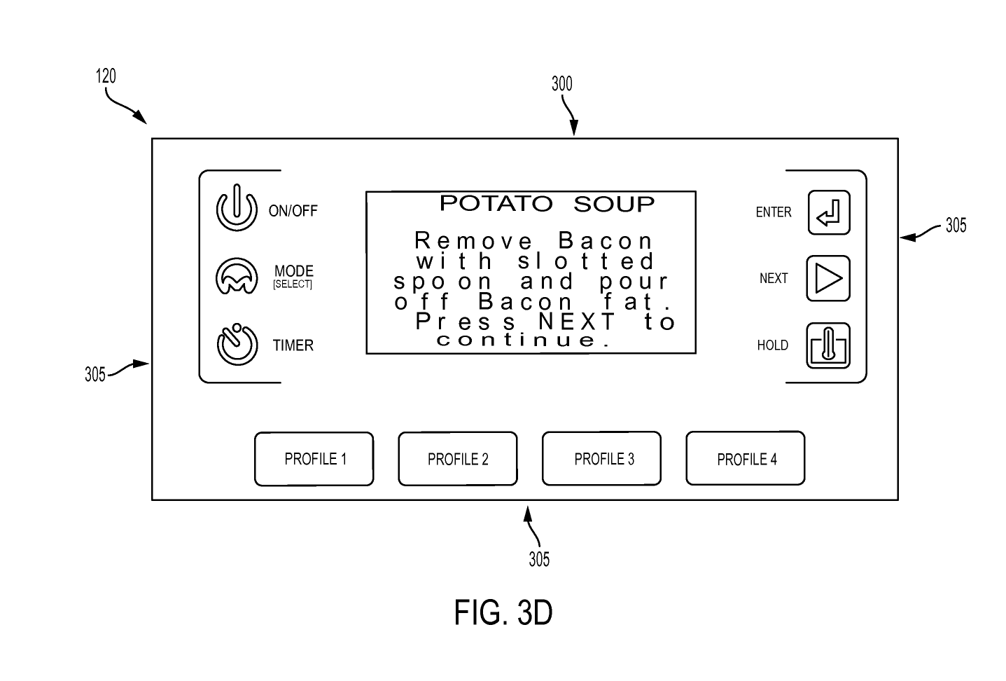

FIGS. 3A-3D illustrate one embodiment of the user-interface 120. In the illustrated embodiment, the user-interface 120 is located on a front portion of the housing 110. The user-interface 120 is communicatively connected to the controller 200 and is used to control and/or monitor the cooking system 100. For example, the user-interface 120 allows a user to input, among other things, the operating temperature of the cooking area 105.

The user-interface 120 includes a combination of digital and analog input or output devices required to achieve a desired level of control and monitoring for cooking system 100. In the illustrated embodiment, the user-interface 120 includes a display 300 and a plurality of user-input mechanisms 305. The display 300 may be, but is not limited to, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), and a thin-film transistor (“TFT”) LCD. The plurality of user-input mechanisms 305 may be, but is not limited to, a plurality of knobs, dials, switches, and buttons. In another embodiment, the user-interface 120 is a touch screen, such as but not limited to, a capacitive touch screen. In some embodiments, the user-interface 120 further includes speakers to provide auditory indications of the status or condition of the cooking system 100.

In one example of operation, a user inputs an operating temperature using the user-interface 120. The controller 200 receives the user input from the user-interface 120 and operates the cooking area 105 at the user-set operating temperature. In various embodiments, the user may input an operating power level instead of an operating temperature.

In another example of operation, explained in further detail below, the user-interface 120 displays practical cooking instructions of a selected recipe to a user via the display 300. In such an operation, as the user proceeds through the recipe, the instructions will be displayed via the display 300. Further, in such an operation, the display 300 can also display status updates and actions to the user.

The cooking system 100 is configured to perform a plurality of different recipes. Each recipe consists of a predetermined program or sequence of steps. Each step may include an instruction phase, an execution phase, or both an instruction phase and an execution phase. In some embodiments which are explained in further detail below, an instruction phase may include displaying an instruction to a user via the display 300 and an execution phase may include actions performed automatically by the cooking system 100 (e.g., heating the cooking area 105, e.g. to a predetermined operating temperature or at a predetermined power level). Although described as separate phases, the instruction phase and the execution phase may be performed simultaneously or progressively.

During an instruction phase of a step, the controller 200 operates the user-interface 120 to display a message on the display 300. The message includes an action that is to be performed by the user. Examples of an action include, but are not limited to, “PLACE PAN ON COOKTOP,” “ADD INGREDIENT,” “CHECK FOOD TEMPERATURE,” and “STIR.” In some instruction phases, once the user has completed the action, a user-input mechanism 305 of the user-interface 120 must be activated before the cooking system 100 proceeds. For example, when the action includes “CHECK FOOD TEMPERATURE,” once the user has completed the action and determines that the food is at an appropriate temperature, the user activates a user-input mechanism 305 to proceed. In those embodiments in which only a power level is set, it is useful for the user to check the food temperature to confirm that the predetermined power level is heating food to the proper degree. In other instruction phases, the instruction phase is performed for a predetermined time period and, once the predetermined time period has elapsed, the cooking system 100 proceeds. For example, when the action includes “STIR,” the instruction is displayed on the display 300 for a predetermined time period. In such an example, once the predetermined time period has elapsed, the cooking system 100 proceeds. Thus, the cooking system 100 proceeds after an event occurs, where the event may include a predetermined time elapsing and an input being received from the user (e.g. the user pressing a user-input mechanism 305 to indicate that the system should go to the next step).

During an execution phase of a step, the controller 200 controls the cooking area 105. For example, during an execution phase, the controller 200 operates the cooking area 105 at a predetermined operating temperature for a predetermined time period. In some embodiments, during the execution phase, the controller 200 operates the user-interface 120 to display a message on the display 300, such as, but not limited to, an alert including the operating temperature of the cooking area 105 and/or the time remaining of the predetermined time period. In various embodiments, the controller may operate the cooking area 105 at a predetermined operating power level rather than at a specific temperature. Given a standardized set of conditions, such as the use of a cooking vessel of a known size, weight, and material and the addition of known amounts of ingredients at a known temperature, it is expected that operating the cooking area 105 at a predetermined operating power level for a predetermined period of time will bring the cooking vessel and its contents to a given temperature in a reproducible manner. In addition, in certain embodiments a temperature measurement may also be taken, for example either manually by the user or automatically when the sensor 107 includes temperature-sensing capabilities as discussed above, to confirm that the correct temperature has been reached and to provide feedback for optimizing the cooking process.

In some embodiments, the plurality of recipes may be stored in the memory 210. In other embodiments, the controller 200 receives the plurality of recipes from an outside device via the communications module 215. In such an embodiment, the plurality of recipes can be user created and then communicated to the controller 200 via the communications module 215.

In some embodiments, once the cooking system 100 has completed a recipe, the controller 200 sets the cooking area 105 to a hold temperature or hold power level to hold the food at a temperature in a range of, e.g., 150-200° F. The hold temperature or power level holds the finished product at a serving temperature, without overcooking the finished product.

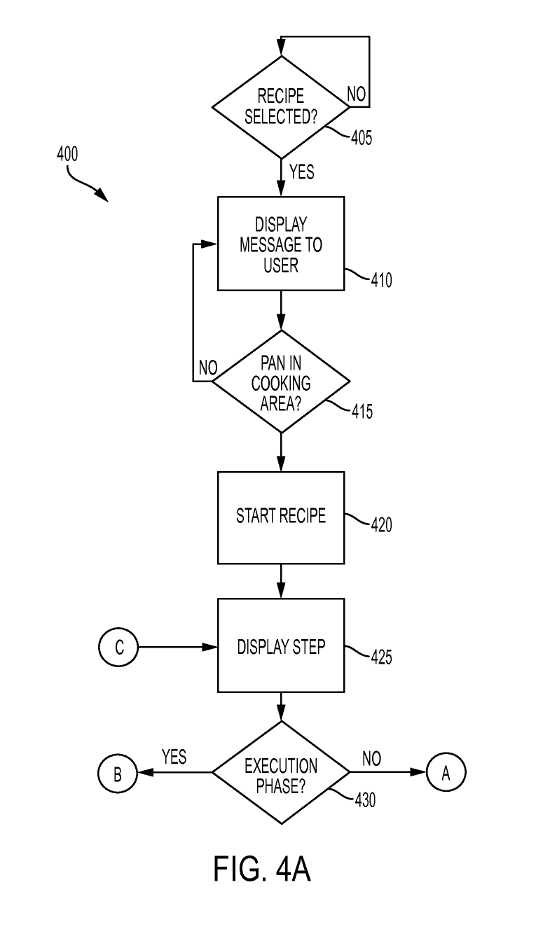

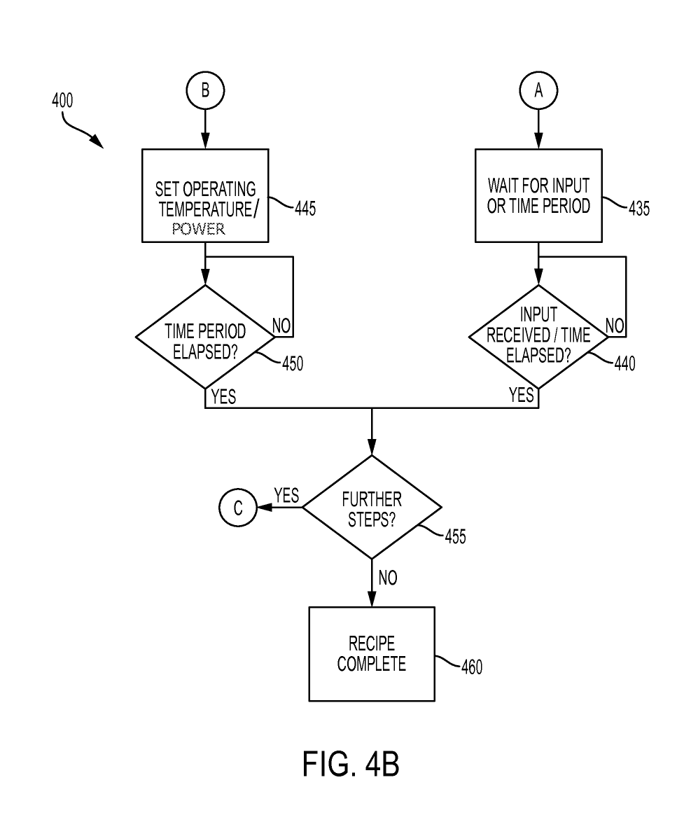

FIGS. 4A and 4B show a flow chart illustrating one embodiment of a process 400 for operation of the cooking system 100. Other embodiments of the process 400 may include more or less steps, including steps such as those discussed above. The controller 200 determines if a recipe has been selected by a user (Step 405). The recipe can be selected in a number of ways, including but not limited to, via the user-interface 120 or from an outside device through the network.

If a recipe has not been selected by the user, the process 400 returns to Step 405. Once a recipe has been selected by the user, the user-interface 120 displays a message to the user, for example an instruction to place a pan on the cooking area 105 (Step 410). The controller 205 then determines if the pan has been placed on the cooking area 105 (Step 415), for example using the sensor 107. If the pan has not been placed on the cooking area 105, the process 400 returns to Step 410.

Once the pan has been placed on the cooking area 105, the controller 200 starts the selected recipe (Step 420). The user-interface 120 displays the current step of the recipe (Step 425). The controller 200 determines if the current step includes an execution phase (Step 430).

If the current step does not include an execution phase, the cooking system 100 waits for an input from the user via the user-interface 120, or a predetermined time period to elapse (Step 435). In various embodiments, the time period may be an amount of time allotted for a user to execute a step such as stirring or adding one or more ingredients. The controller 200 then determines if the user input has been received, or if the predetermined time period has elapsed (Step 440). If the user input has not been received, or the predetermined time period has not elapsed, the process 400 returns to Step 440. If the user input has been received, or the predetermined time period has elapsed, the process 400 proceeds to Step 455. Thus, if the predetermined time elapses before user input is received, it is possible in some instances that the process 400 may proceed to a next step without receiving confirmation from the user that the instructed action (e.g. stirring or adding an ingredient) was completed.

If in Step 430 it is determined that the current step includes an execution phase, the controller 200 sets the cooking area 105 to the predetermined operating temperature (Step 445). The controller 200 determines if cooking area 105 has operated at the predetermined operating temperature for a predetermined time period (Step 450). If the cooking area 105 has not operated at the predetermined operating temperature for the predetermined time period, the process 400 returns to Step 450. If the cooking area 105 has operated at the predetermined operating temperature for the predetermined time period, the process 400 proceeds to Step 455. In certain embodiments, a predetermined operating power level may be set instead of, or in addition to, a predetermined temperature at step 445.

Upon a determination of YES in Step 440 or Step 450, the controller 200 determines if there are further steps of the recipe (Step 455). If there are no further steps of the recipe, the user-interface 120 displays that the recipe is complete and/or generates an audible alarm (Step 460). If there are further steps of the recipe, the process 400 returns to Step 425.

In one embodiment, the cooking system 100 is communicatively connected to one or more other cooking systems or cooking appliances. In such an embodiment, the one or more cooking systems may be connected through a network. A recipe may require the use of the one or more cooking systems. Therefore, as the recipes proceeds, the one or more cooking systems communicate with each other and perform the various function dictated by the recipe. This results in an expedited process and allows for better timing when one or more cooking systems are needed.

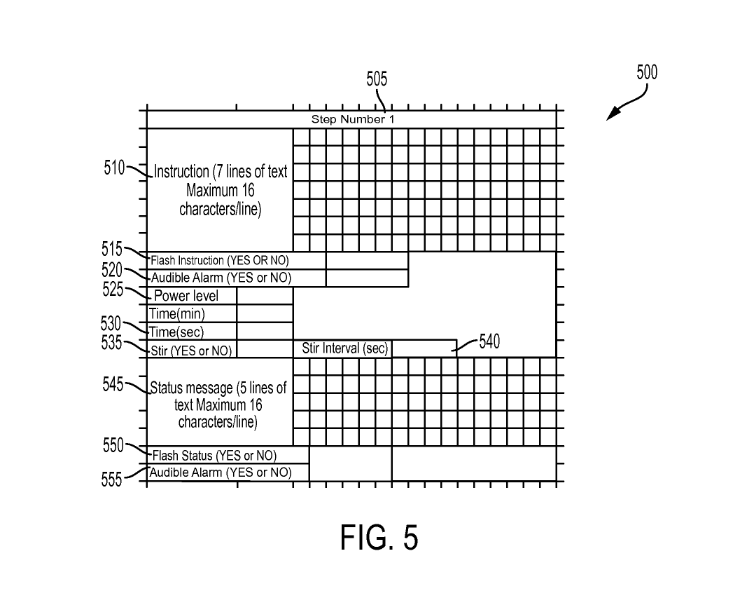

FIG. 5 illustrates one embodiment of a recipe program, or recipe builder, 500. The recipe program 500 allows a user to create recipes, which are subsequently implemented by the cooking system 100. In some embodiments, the recipe program 500 is used on a platform that is remote from the cooking system 100. In such an embodiment, the recipes created using the recipe program 500 are transmitted to the cooking system 100, for example but not limited to, by the communications module 215. The recipe program 500 may be configured to run in a Windows environment (e.g., Windows XP, 7, 8, 10, etc.), a Macintosh environment (e.g., OSX, etc.), or any other graphical operating system or environment. In other embodiments, the recipe program 500 is a web-based (browser-accessible) application. In yet another embodiment, the recipe program 500 is compatible with mobile devices (e.g., smartphones and tablets) including devices using iOS, Android, Blackberry, Windows Mobile, or other mobile device operating systems.

In some embodiments, the user can create recipes using the recipe program 500, which may be computer software, such as a computer application or a smart phone application. In some embodiments, the recipe program includes a plurality of recipe steps 505 (i.e., “Step Number 1”, “Step Number 2”, etc.). The plurality of recipe steps 505 includes a plurality of inputs. Other embodiments of the recipe program, or recipe steps 505, may include more or less inputs.

Recipe step 505 includes an instruction input 510, which allows the user to enter the recipe instructions. Recipe step 505 further includes a flash instruction input 515, which allows the user to activate the user-interface 120 to display the current instruction. Recipe step 505 further includes a first audible alarm input 520, which allows the user to activate the user-interface 120 to provide an audible alarm that the current step of the recipe has begun. Recipe step 505 further includes a power level input 525, which allows the user to set the power level of the cooking area 105 during recipe step 505. In various embodiments, the recipe program 500 may display a field for entering a desired temperature (e.g. in a range of 100° F.-500° F.) instead of, or in addition to, the power level setting at recipe Step 505. Recipe Step 505 further includes a time input 530, which allows the user to enter the operating time of recipe step 505. Recipe step 505 further includes a stir input 535, which allows the user to activate the stir option during recipe step 505. In some embodiments, when the stir option is activated the user-interface 120 displays a stir instruction to the user. If the user activates the stir option at the stir input 535, the user can enter a stir time into a stir interval input 540. The recipe step 505 further includes a status message input 545, which allows the user to input a status message to be displayed on the user-interface 120 during recipe step 505. The recipe step 505 further includes a flash status input 550, which allows the user to activate the user-interface 120 to display the inputted status message. The recipe step 505 further includes a second audible alarm input 555, which allows the user to activate the user-interface 120 to provide an audible alarm that the current step of the recipe has completed.

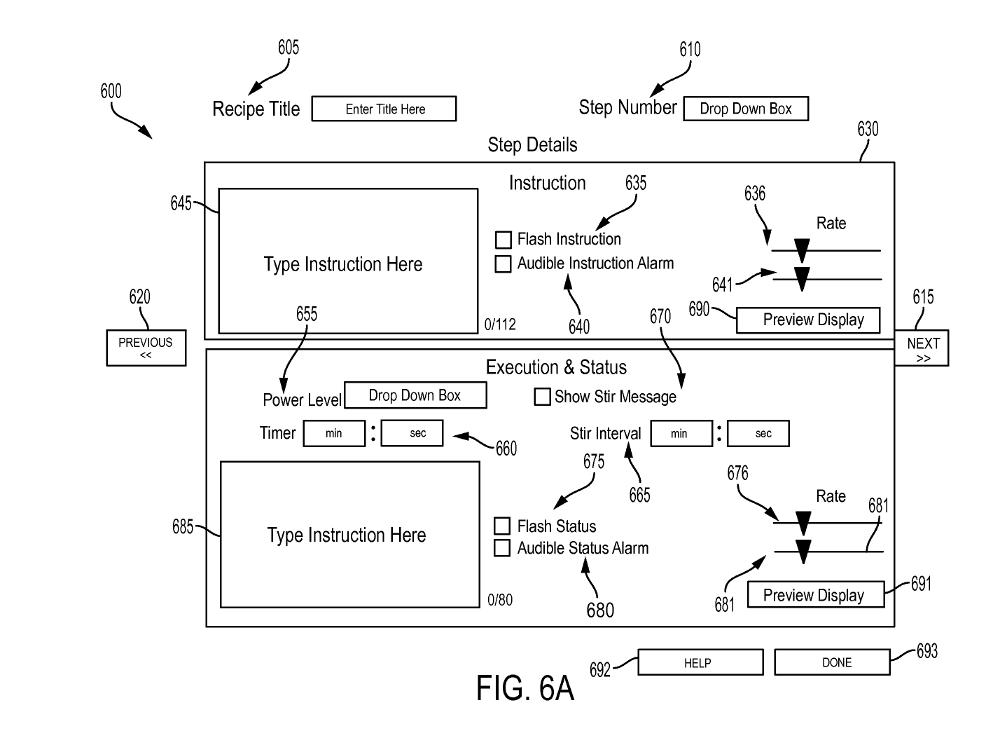

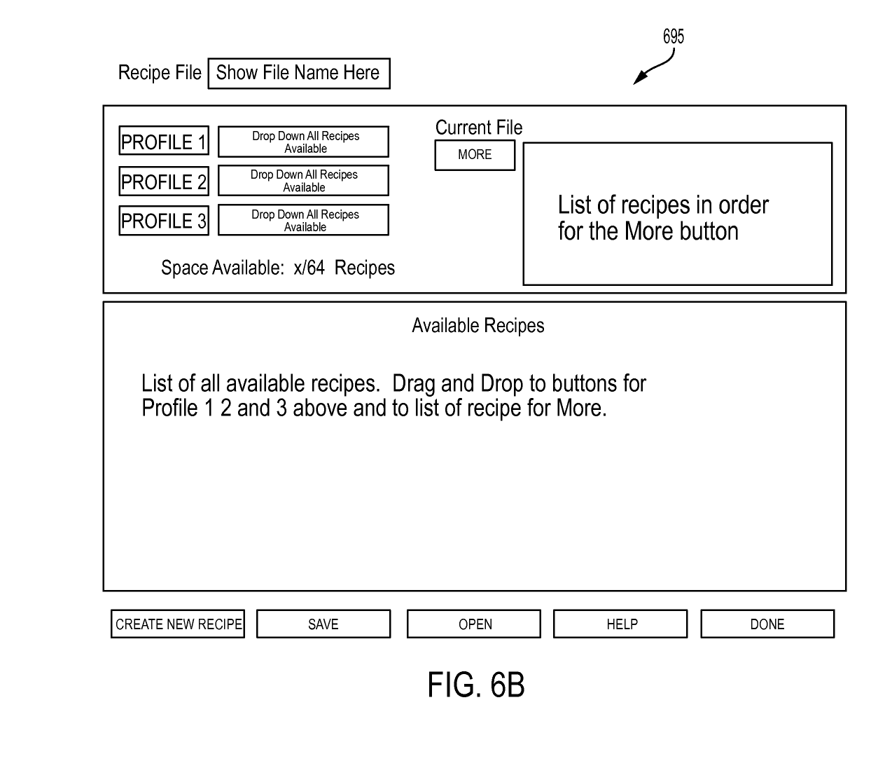

FIGS. 6A and 6B illustrate another embodiment of a recipe program 600. In some embodiments, recipe program 600 is substantially similar to recipe program 500. Recipe program 600 includes a first segment and a second segment. The first segment allows creation of new recipes, as well as modification of existing recipes. The second segment provides a utility to manage recipes to be downloaded/transmitted to the cooking system 100.

Recipe program 600 includes a recipe title 605 and a step number 610. The recipe title 605 may be a text string having up to sixteen characters and may be any combination of standard ASCII characters. The step number 610 is a variable for each step of a recipe. The step number 610 provides an order of the steps for the recipe to follow. The step number 610 increments from 1 to the maximum number of steps (e.g., 20, 50, 100, 100+, etc.) for each step of the recipe. When the step number 610 is less than the maximum number of steps, a NEXT button 615 appears. A user clicking the NEXT button 615 will move the user to the next highest step of the recipe. When the step number 610 is greater than 1, a PREVIOUS button 620 will appear to the left of the recipe data portion of the screen. Clicking on the PREVIOUS button 620 will move the user to the next lowest step number of the recipe.

For each step of a recipe, the recipe program 600 displays a screen area (e.g., on an LCD screen) for an instruction area 630. The instruction area 630 may include a flash instruction check box 635, an audible instruction alarm check box 640, and an instruction text box 645. The instruction area 630 will show the screen as it would appear on the cooking system 100 (e.g., the display 300) and allow the user to enter text (e.g., seven lines, sixteen characters per line, or greater) into the instruction text box 645. In some embodiments, the text may be any combination of ASCII characters.

For each step of a recipe, the recipe program 600 further displays a screen area (e.g., on an LCD screen) for an execution and status area 650. The execution and status area 650 may include fields for power level 655, time 660 (e.g. minutes and seconds), and stir interval 665. Additionally, the execution and status 650 may further include a show stir message check box 670, a flash status check box 675, an audible status alarm check box 680, and an execution and status text box 685. The power level 655 may be a number between 0 and 100. In such an embodiment, no other characters are generally allowed and the number is typically limited to this range. The execution and status area 650 will show the screen as it would appear on the cooking system 100 (e.g., the display 300) and allow the user to enter text (e.g., seven lines, sixteen characters per line, or greater) into the execution and status text box 685. In some embodiments, the text may be any combination of ASCII characters. In various embodiments, the recipe program 600 may display a field for entering a desired temperature (e.g. in a range of 100° F.-500° F.) instead of, or in addition to, the power level 655 setting.

Both the instruction text box 645 and the execution and status text box 685 may include a character counter at the lower right hand corner of the respective box. The counter may show the current number of characters used and the total number of characters allowed.

If the box is checked for the flash instruction check box 635, the audible instruction alarm check box 640, the flash status check box 675, or the audible status alarm check box 680, a respective slider 636, 641, 676, or 681 may appear. The sliders 636, 641, 676, or 681 may be used to set the respective flash rates or audible (e.g., beep) rates. The minimum flash rate may be once every 2 seconds. The maximum flash rate may be three times per second with steps of 0.1 second between flashes (a total of sixteen steps). The minimum beep rate may be once every two seconds. The maximum beep rate may be five times per second with steps of 0.1 second between.

An instruction preview button 690 and an execution and status preview button 691 may be provided which allows the user to see the instruction and/or execution and status combined with the selected flashing and beeping options shown on the screen.

In various embodiments, timer entry and stir interval can be in units of minutes and/or seconds. In various embodiments, timer minutes can be a number between 0 and 240. In certain embodiments, no other characters are allowed and the number is limited to this range. In other embodiments, timer seconds include a number between 0 and 60. In some embodiments, no other characters are allowed and the number is limited to this range.

The stir interval 665 may be a number between zero and an upper limit such that the total time for the stir interval does not exceed the timer for the particular step involving stirring, and no other character are generally allowed. Data cannot be entered in this box unless the show stir message check box 670 is selected.

In some embodiments, holding a mouse pointer over each of the elements of the screen will display a brief screen tip. In mobile or other touch-screen embodiments, similar information may be elicited in other ways, for example the user touching and holding their finger on a field for a certain amount of time (e.g. two seconds), quickly double-tapping on the field, or other ways of indicting to the system that an alternate selection (besides touching or clicking the item to make a standard selection) is desired. In still other embodiments, a help button 692 at the bottom of the screen may be available to launch a help file.

Once the user has finished creating the recipe, the done button 693 may be selected. In some embodiments, selecting the done button 693 saves the recipe and closes the recipe program 600. In certain embodiments a maximum of sixty-four recipes can be created and stored. Recipe files may be created and stored according to the prescribed memory map.

FIG. 6B illustrates a recipe manager 695 of the recipe program 600. The recipe manager 695 allows the user to manage a plurality of recipes. The recipe manager 695 may have a drag-and-drop interface to allow for recipes to be assigned to the buttons on the cooktop and to a list assigned to the fourth profile button on the cooktop. In some embodiments, the recipe manager 695 is a home screen for the recipe program 600. In such an embodiment, the recipe manager 695 will allow a user to create a new recipe, save a recipe, and open a saved recipe.

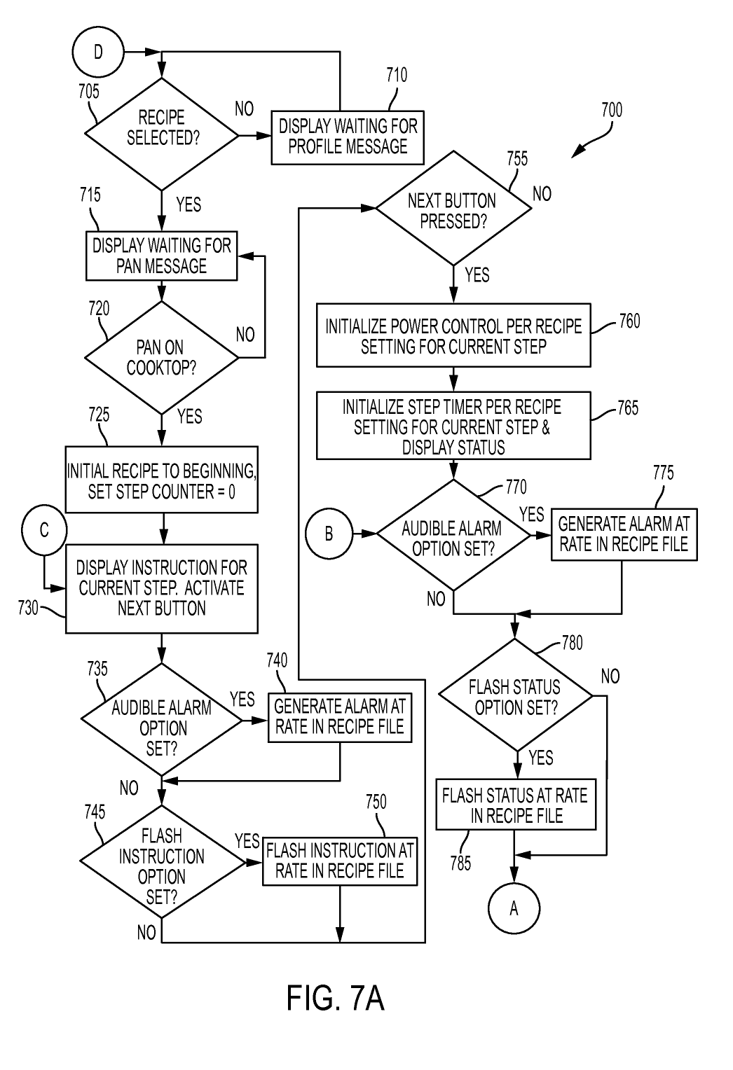

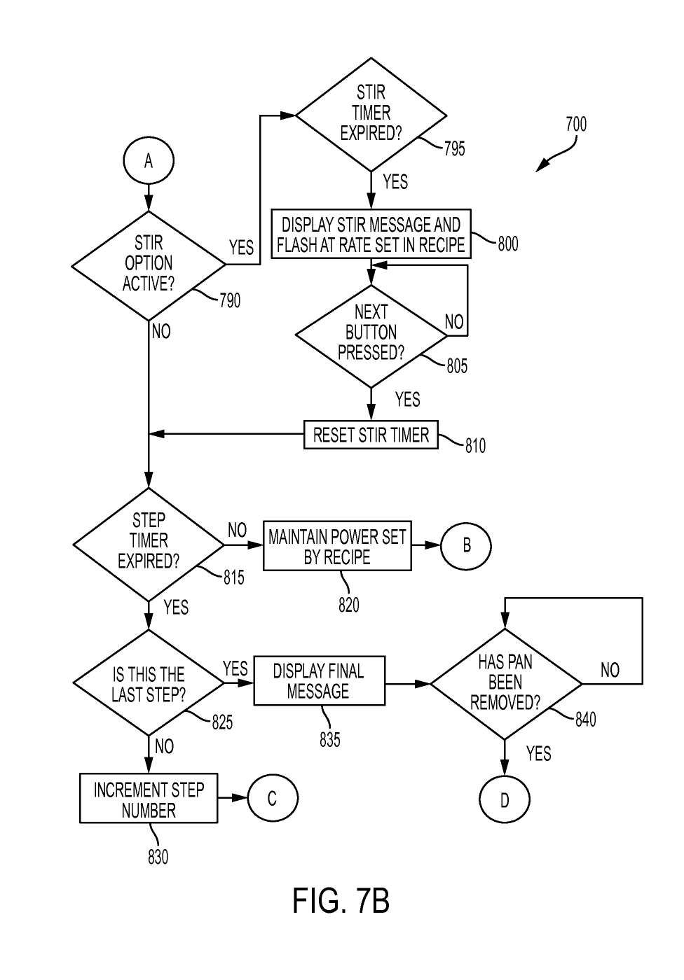

FIGS. 7A and 7B show a flow chart illustrating another embodiment of a process 700 for operation of the cooking system 100. In various embodiments, the cooking system includes an execution module for executing recipes, the execution module including the controller 200 in communication with a user interface and a cooking system, where the controller 200 is configured to carry out steps for executing recipes such as those generated by one or both of the recipe programs 500, 600. Other embodiments of the process 700 may include more or fewer steps, including steps such as those discussed above. The controller 205 determines if a recipe has been selected by a user (Step 705). If a recipe has not been selected by the user, the user-interface 120 displays a waiting message to the user (Step 710). If a recipe has been selected by the user, the user-interface 120 displays a message to the user to place a pan on the cooking area 105 (Step 715). The controller 205 then determines if the pan has been placed on the cooking area 105 (Step 720). If the pan has not been placed on the cooking area 105, the process 700 returns to Step 715.

If the pan has been placed on the cooking area 105, the controller 200 begins the recipe and sets the recipe step counter to zero (Step 725). The user-interface 120 displays the current step of the recipe (Step 730). The controller 200 determines if an audible alarm option has been set (Step 735). If the audible alarm option has been set, the user-interface 120 generates an alarm at a predetermined rate while performing the recipe (Step 740). If the audible alarm option has not been set, the controller 200 determines if a flash instruction option has been set (Step 745). If the flash instruction option has been set, the user-interface 120 displays and flashes the current recipe instruction at a predetermined rate while performing the recipe (Step 750). The process 700 then proceeds to Step 755. If the flash instruction option has not been set, the user-interface 120 does not display or flash the current recipe instruction at the predetermined rate while performing the recipe. The process 700 then proceeds to Step 755.

The controller 200 determines if a next button, of the plurality of user-input mechanisms 305, has been pressed by the user (Step 755). If the next button has not been pressed, the process 700 returns to Step 755. If the next button has been pressed, the controller 200 sets the cooking area 105 to a predetermined operating power (or temperature) level, as dictated by the current step of the recipe (Step 760). The controller 200 then initializes a step timer to a predetermined time period, as dictated by the current step of the recipe (Step 765). The controller 200 then determines if the audible alarm option has been set (Step 770). If the audible alarm option has been set, the user-interface 120 generates an alarm at a predetermined rate while performing the recipe (Step 775). If the audible alarm option has not been set, the controller 200 determines if a flash instruction option has been set (Step 780). If the flash instruction option has been set, the user-interface 120 displays and flashes the current recipe instruction at a predetermined rate while performing the recipe (Step 785). The process 700 then proceeds to Step 790. If the flash instruction option has not been set, the user-interface 120 does not display or flash the current recipe instruction at the predetermined rate while performing the recipe. The process 700 then proceeds to Step 790.

The controller 200 determines if a stir option is active (e.g., does the current recipe require stirring by the user?) (Step 790). If the stir option is active, the controller 200 determines if a stir timer has expired (Step 795). If the stir timer has not expired, the process 700 returns to Step 795. If the stir timer has expired, the user-interface 120 displays a stir message (Step 800). The controller 200 determines if the next button has been pressed by the user (Step 805). If the next button has not been pressed, the process 700 returns to Step 805. If the next button has been pressed, the controller 200 resets the stir timer (Step 810).

If the stir option has not been set, the controller 200 determines if the step timer, of Step 765, has expired (Step 815). If the step timer has not expired, the controller 200 maintains the cooking area 105 at the predetermined operating power (or temperature) level of Step 760 (Step 820), the process 700 then returns to Step 770. If the step timer has expired, the controller 200 determines if the current step is the last step of the recipe (Step 825). If the current step is not the last step of the recipe, the controller 200 increments the step counter (Step 830) and process 700 returns to Step 730. If the current step is the last step of the recipe, the user-interface 120 displays the final message (Step 835). The controller 200 then determines if the pan has been removed from the cooking area 105 (Step 840). If the pan has not been removed, process 700 returns to Step 840. If the pan has been removed, process 700 returns to Step 705.

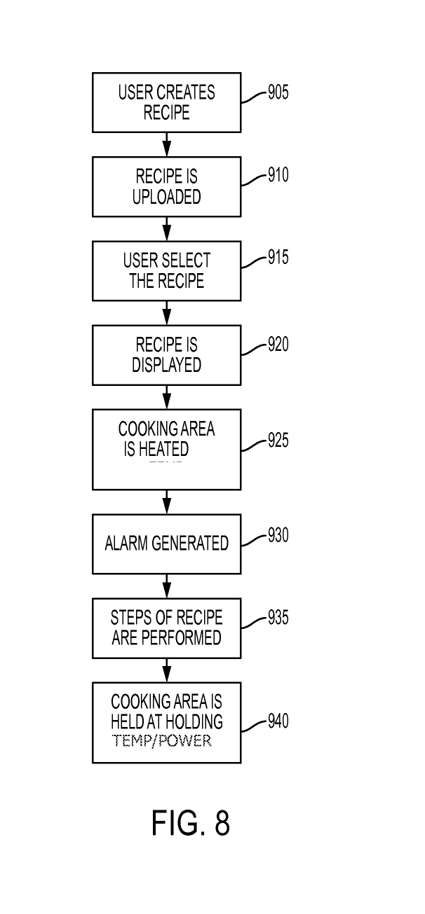

FIG. 8 illustrates a plurality of steps of a further embodiment of an operation 900 of the cooking system 100. The user (i.e., chef) creates a recipe using the recipe program 500 (Step 905). The recipe is uploaded to the cooking system 100 (Step 910). The user selects the recipe using the user-interface 120 (Step 915). The recipe step is displayed using the user-interface 120 (Step 920). The cooking area 105 is heated, for example to the desired operating temperature or power level (Step 925). An audible alarm is generated by the user-interface 120 to indicate that the step is completed (Step 930). Each step of the recipe is displayed on the user-interface 120; the user interacts with the user-interface 120, as necessary, to proceed through the remaining steps of the recipe (Step 935). The cooking area 105 is heated, for example to a desired hold temperature or power level in order to prevent overcooking (Step 940).

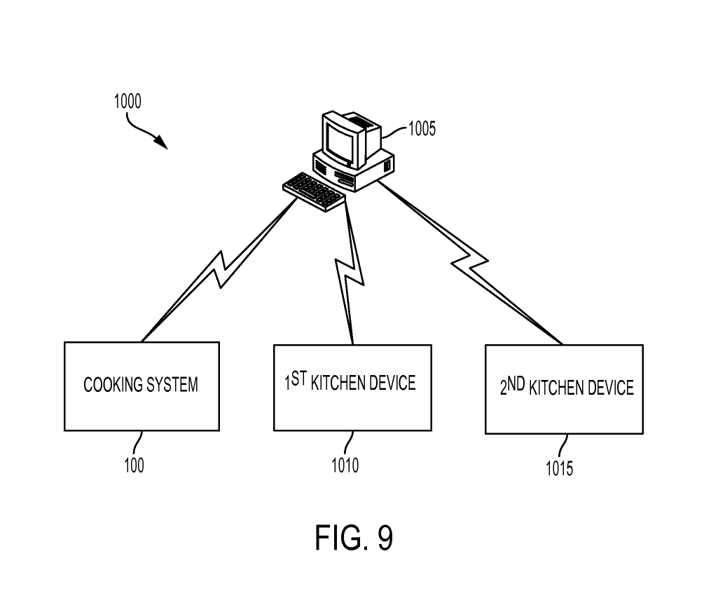

FIG. 9 illustrates a network 1000. The network 1000 includes a main computer 1005, at least one cooking system 100, and at least one or more kitchen devices (e.g., a first kitchen device 1010 and a second kitchen device 1015). The main computer 1005 manages a recipe, which may be implemented by the cooking system 100 and the one or more kitchen devices 1010, 1015. For example, one or more steps of the recipe may be performed by the cooking system 100, while one or more additional steps may be performed by one or more kitchen devices 1010, 1015. In such an example, once one or more steps are completed using the cooking system 100, the display 300 instructs the user to move the cooking vessel to the first kitchen device 1010. The user moves the cooking vessel to the first kitchen device 1010 and operates the user-interface of the first kitchen device 1010 to confirm that the cooking vessel has been moved. The main computer 1005 receives confirmation from the first kitchen device 1010, and manages the recipe to move to the next step. Once one or more steps are completed using the first kitchen device 1010, the display of the first kitchen device 1010 instructs the user to move the cooking vessel to the second kitchen device 1015. The user moves the cooking vessel to the second kitchen device 1015 and operates the user-interface of the second kitchen device 1015 to confirm that the cooking vessel has been moved. The main computer 1005 receives confirmation from the second kitchen device 1015, and manages the recipe to move to the next step using the second kitchen device 1015. In some embodiments, the main computer 1005 may perform multiple steps of a recipe simultaneously on multiple kitchen devices (e.g., cooking system 100 and the one or more kitchen device 1010, 1015).

In some embodiments, the communications module 215 of the cooking system 100 is communicatively coupled to the network 1000. In such an embodiment, the cooking system 100 may receive complete recipes from the main computer 1005, or individual steps from the main computer 1005 as the recipe proceeds.

In some embodiments, the network 1000, and main computer 1005, may gather data of the cooking system 100 and one or more kitchen devices 1010, 1015. In such an embodiment, the data may be used to plan for future demand of particular menu items (e.g., produce, meats, etc.), know how often the cooking system 100 or other kitchen devices 1010, 1015 are used, know how much energy is used by the cooking system 100 or other kitchen devices 1010, 1015 (in order to conserve energy in the future), or to improve operations by changing/adding equipment, staff, and/or menu items.

Thus, the invention provides, among other things, a cooking system that automatically performs a series of steps of a recipe. The cooking system of the present invention has the advantage of producing food with consistent quality, regardless of the culinary training of the operator. Various features and advantages of the invention are set forth in the following claims.

What is claimed is:

1. An induction cooking apparatus comprising:
a heating element;
a user-interface having a user-input mechanism for receiving at least one input from a user and a display for presenting at least one instruction to the user; and
a controller configured to perform a recipe, the recipe including
an instruction phase, the instruction phase including operating the display to present an instruction to the user until at least one event occurs, the event selected from the group of events consisting of a first predetermined time elapsing and an input being received from the user, and
an execution phase, the execution phase including operating the heating element at a predetermined temperature or power level until a second predetermined time has elapsed.

2. The induction cooking apparatus of claim 1, further comprising a sensor configured to sense a cooking vessel.

3. The induction cooking apparatus of claim 2, wherein the controller does not perform the recipe until a cooking vessel is sensed using the sensor.

4. The induction cooking apparatus of claim 1, wherein the predetermined temperature or power level is a holding temperature or power level for holding a food product at a serving temperature.

5. The induction cooking apparatus of claim 1, further including a communications module configured to receive the recipe from an external device.

6. The induction cooking apparatus of claim 1, wherein the induction cooking apparatus is communicatively coupled to a second induction cooking apparatus.

7. The induction cooking apparatus of claim 1, wherein the recipe is created using a recipe program.

8. The induction cooking apparatus of claim 7, wherein the recipe program is stored on a memory of the controller.

9. The induction cooking apparatus of claim 7, wherein the recipe program is stored on an external device.

10. A method of controlling an induction cooking appliance, the method comprising the steps of:
receiving a recipe;
displaying an instruction to a user according to the recipe, the instruction being displayed until at least one event occurs, the event selected from the group of events consisting of a first predetermined time elapsing and an input being received from the user; and
operating a heating element of the induction cooking appliance according to the recipe, the heating element being operated at a predetermined temperature or power level until a second predetermined time has elapsed.

11. The method of claim 10, wherein the recipe is received from an external device.

12. The method of claim 10, further comprising sensing a cooking vessel after receiving the recipe.

13. The method of claim 12, wherein the instruction is not displayed to the user until the cooking vessel is sensed.

14. The method of claim 12, wherein the heating element is not operated until the cooking vessel is sensed.

15. The method of claim 10, wherein the predetermined temperature or power level is a holding temperature or power level for holding a food product at a serving temperature.

16. The method of claim 10, wherein the recipe is created using a recipe program.

17. An induction cooking appliance network system comprising:
a first induction cooking appliance including a first heating element and a first user-interface;
a second induction cooking appliance communicatively coupled to the first induction cooking appliance, the second induction cooking appliance including a second heating element and a second user-interface; and
a main computer communicatively coupled to the first induction cooking appliance and the second induction cooking appliance, the main computer operable to
display an instruction according to a recipe to a user via at least one interface selected from the group of interfaces consisting of the first user-interface and the second user-interface, the instruction being displayed until at least one event occurs, the event selected from the group consisting of a first predetermined time elapsing and an input being received from the user, and
operate at least one heating element selected from the group of heating elements consisting of the first heating element and the second heating element according to the recipe, wherein the selected heating element, when operated, is operated at a predetermined temperature or power level until a second predetermined time has elapsed.

18. The induction cooking appliance network system of claim 17, wherein the recipe is created via a recipe program stored on a memory of the main computer.

19. The induction cooking appliance network system of claim 18, wherein the recipe is received from an external device.

20. The induction cooking appliance network system of claim 17, wherein
the first induction cooking appliance includes a first sensor configured to sense a first cooking vessel; and
the second induction cooking appliance includes a second sensor configured to sense a second cooking vessel.

21. A computer-based recipe creation and management system, comprising:
a recipe builder module for creating a recipe having one or more steps, each step of the recipe builder module including an instruction area and an execution and status area, wherein
the instruction area includes one or more of the following user inputs
an instruction text input,
a flash instruction input, and
an audible instruction alarm input, and
the execution and status area includes one or more of the following user inputs
a temperature or power level input,
a time input,
a show stir message input,
a stir interval input,
a flash status input,
an audible status alarm input, and
an execution and status text box input;
an execution module for executing recipes, the execution module including a controller in communication with a user interface and an induction cooking system, the controller configured to
determine if a recipe has been selected by a user,
detect a pan on a cooking area of the induction cooking system,
display a first step of the recipe selected by the user on the user interface, and
adjust a temperature or power level of the cooking area of the induction cooking system.

22. The computer-based recipe creation and management system of claim 21, wherein, if at least one of the flash instruction input, the audible instruction alarm input, the flash status input, or the audible status alarm input is selected, the recipe builder module presents a slider for adjusting a rate for the selected input.

23. The computer-based recipe creation and management system of claim 21, wherein the controller is further configured to display a stir message if the show stir message input is selected in the recipe and after a stir timer time expires.

24. The computer-based recipe creation and management system of claim 21, wherein the controller generates an audible alarm if the audible status alarm input is selected.

25. The computer-based recipe creation and management system of claim 21, wherein the controller executes a second step of the recipe if a next button is selected on the user interface.

25. The computer-based recipe creation and management system of claim 21, further comprising a recipe manager module for creating new recipes, saving new or modified recipes, and opening saved recipes.
